(19) United States
(12) Patent Application Publication
(10) Pub. No.: US 2025/0144914 A1
(43) Pub. Date: May 8, 2025

(54) ANTENNA AND METHOD FOR MANUFACTURING THE SAME

(71) Applicant: HL KLEMOVE CORP., Incheon (KR)

(72) Inventors: Seung-Hun LEE, Incheon (KR); Hyun-Yong LEE, Incheon (KR); Seok-Jin KIM, Incheon (KR); Seong-Wook LEE, Incheon (KR); Ki-Hoon PARK, Incheon (KR); Ji-Hoon JUNG, Incheon (KR)

(21) Appl. No.: 18/648,336

(22) Filed: Apr. 27, 2024

(30) Foreign Application Priority Data
Nov. 2, 2023 (KR) 10-2023-0150094

(51) Int. Cl. B32B 15/01; B32B 3/26; B32B 15/08; B32B 37/00; B32B 38/10; H01Q 21/00

(52) U.S. Cl. CPC B32B 15/012; B32B 3/26; B32B 15/08; B32B 37/0038; B32B 38/10; H01Q 21/0087; B32B 2250/02; B32B 2305/026; B32B 2310/0409; B32B 2311/24; B32B 2371/00; B32B 2457/00

(57) ABSTRACT

An antenna may comprise a body including at least one first layer formed of metal and at least one second layer formed of resin, the first layer and the second layer being thermally fused to each other; and a waveguide formed in the body. A method for manufacturing an antenna may comprise heating a first layer formed of metal; and bonding the heated first layer formed of the metal and a second layer formed of resin so that the first layer and the second layer are thermally fused to each other to form a waveguide in a body of the antenna. The antenna and the method for manufacturing the antenna may save the weight and material costs by reducing the number of components and assembly processes, reduce the overall size, prevent damage during the assembly process.

### CROSS-REFERENCE TO RELATED APPLICATION

This application claims priority to and benefit from Korean Patent Application No. 10-2023-0150094, filed on Nov. 2, 2023, which is hereby incorporated by reference for all purposes as if fully set forth herein.

### BACKGROUND

### Field

The present disclosure generally relates to an antenna and a method for manufacturing the same and, more specifically, to an antenna capable of saving the weight and material costs by reducing the number of components and assembly processes, reducing the overall size, preventing damage during the assembly process, and providing enhanced quality and a method for manufacturing the same.

### Description of Related Art

An antenna is a device that may radiate radio waves and identify the presence or absence of an object, and the distance, moving direction and moving speed of an object by the radio waves reflected or scattered by the object. For example, an antenna may be equipped in a variation to be used to recognize, e.g., surrounding people or things.

### BRIEF SUMMARY

Some embodiments of the present disclosure may relate to an antenna capable of saving the weight and material costs by reducing the number of components and assembly processes, reducing the overall size, preventing damage during the assembly process, and provide enhanced quality and a method for manufacturing the same.

According to the present embodiments, there may be provided an antenna comprising a body including at least one first layer formed of metal and at least one second layer formed of resin, the first layer and the second layer being thermally fused to each other and a waveguide formed in the body.

According to the present embodiments, there may be provided a method for manufacturing an antenna including a body including at least one first layer formed of metal and at least one second layer formed of resin, the first layer and the second layer being thermally fused to each other and a waveguide formed in the body, comprising preparing a first layer and a second layer, heating the first layer, and bonding the first layer and the second layer.

According to certain embodiments of the present disclosure, it is possible to save the weight and material costs by reducing the number of components and assembly processes, reduce the overall size, prevent damage during the assembly process, and provide enhanced quality and a method for manufacturing the same.

### BRIEF DESCRIPTION OF DRAWINGS

The above and other objects, features, and advantages of the disclosure will be more clearly understood from the following detailed description, taken in conjunction with the accompanying drawings, in which:

FIG. 1 is an exploded perspective view illustrating an antenna according to an embodiment of the present disclosure;

FIG. 2 is an exploded perspective view illustrating an antenna according to an embodiment of the present disclosure;

FIG. 3 is a cross-sectional view illustrating an antenna according to an embodiment of the present disclosure;

FIG. 4 is a cross-sectional view illustrating an antenna according to an embodiment of the present disclosure; and

FIG. 5 is a flowchart illustrating a method for manufacturing an antenna according to an embodiment of the present disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A) ”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

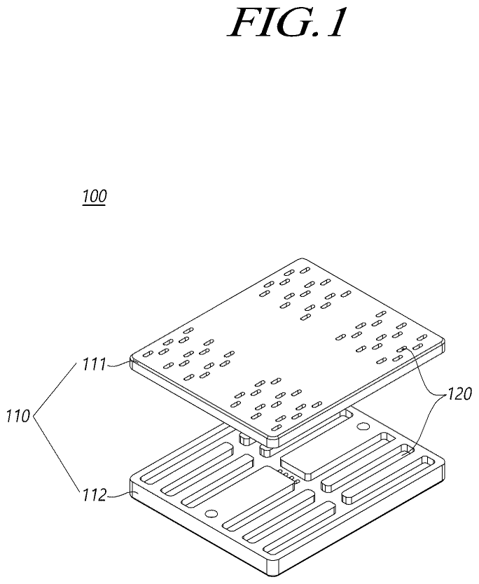

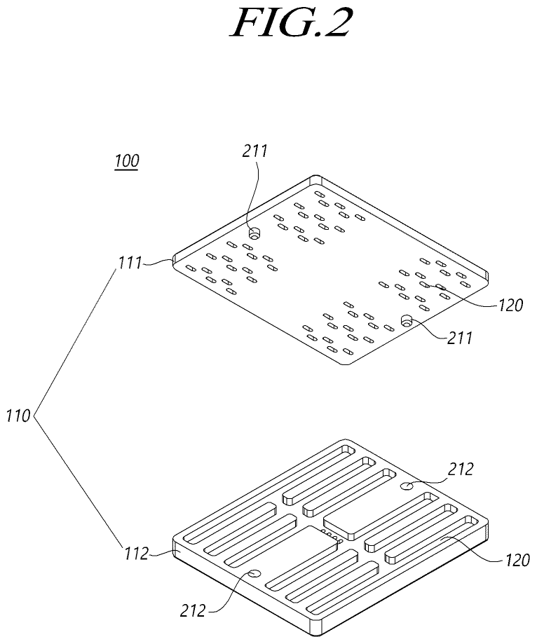

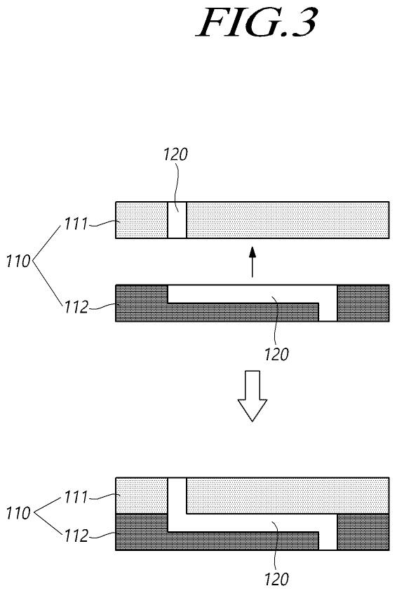

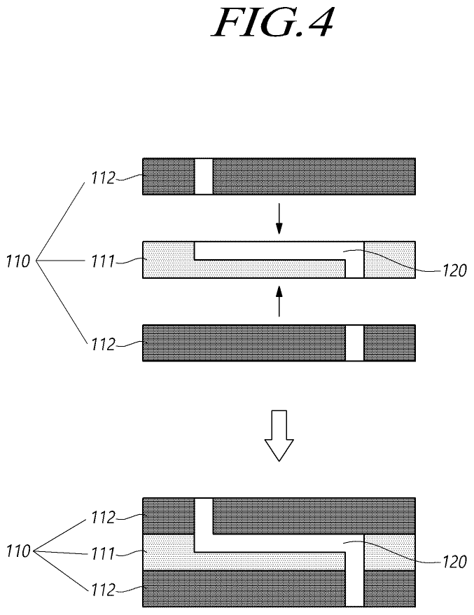

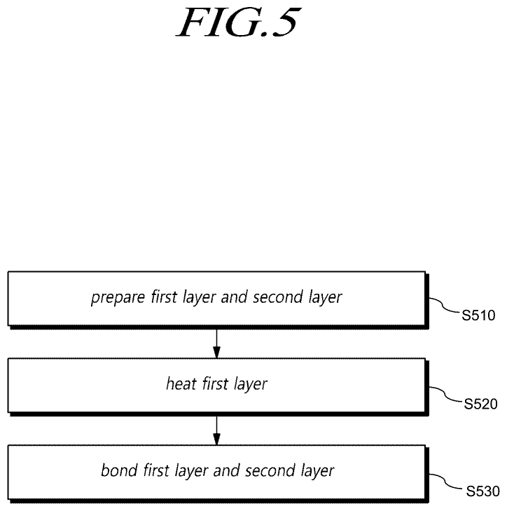

FIG. 1 is an exploded perspective view illustrating an antenna according to an embodiment of the present disclosure. FIG. 2 is an exploded perspective view illustrating an antenna according to an embodiment of the present disclosure. FIG. 3 is a cross-sectional view illustrating an antenna according to an embodiment of the present disclosure. FIG. 4 is a cross-sectional view illustrating an antenna according to an embodiment of the present disclosure. FIG. 5 is a flowchart illustrating a method for manufacturing an antenna according to an embodiment of the present disclosure.

According to some embodiments the present disclosure, an antenna 100 may comprise a body 110 including at least one first layer 111 formed of metal and at least one second layer 112 formed of resin. The first layer 111 and the second layer 112 may be thermally fused to each other and a waveguide 120 formed in the body 110.

Referring to FIG. 1, the antenna 100 according to the present embodiment includes the body 110 and a waveguide 120 formed in the body 110. The body 110 includes one or more first layers 111 and one or more second layers 112. FIG. 1 illustrates the antenna 100 in which the body 110 includes one first layer 111 and one second layer 112.

In the present embodiment, the first layer 111 and the second layer 112 are thermally fused. In this case, the first layer 111 is formed of metal, and the second layer 112 is formed of resin. More specifically, in certain embodiments of the present disclosure, if the first layer 111 formed of metal is heated and then the second layer 112 formed of resin is bonded thereto, the second layer 112 is thermally fused to the first layer 111.

In an alternative embodiment, a structure in which a plurality of layers included in an antenna may be fastened by screws. Such a structure requires a plurality of screw components and a fastening process, so that the number of components is too large and the process is complicated, and the total weight of the antenna is increased by the weight of the screws. Further, portions where the screws are to be fastened to the antenna body are required, leading to an increase in the overall size of the antenna. Further, as the antenna body is commonly formed of PPS, chips and cracks may be caused in the layers due to excessive assembly torque during the screwing process, deteriorating the quality of the antenna.

However, the antenna 100 according to some embodiments of the present disclosure has a structure in which the first layer 111 and the second layer 112 of the body 110 are thermally fused and coupled to each other, which may reduce the number of components and assembly processes to save the weight and material costs, reduce the overall size, and prevent damage during the assembly process, and enhance quality. Referring to FIG. 1, the lower surface of the first layer 111 and the upper surface of the second layer 112 may be thermally fused, and the waveguide 120 is entirely formed in the first layer 111 and the second layer 112, and no separate portion for fastening is required. Referring to FIG. 2, the first layer 111 and the second layer 112 may have pins 211 and holes 212 for guiding bonding during thermal fusion. FIG. 2 illustrates a structure in which pins 211 are formed on the lower surface of the first layer 111 and holes 212 are formed in the upper surface of the second layer 112.

Referring to FIG. 3, the body 110 of the antenna 100 according to the present embodiments may include one first layer 111 and one second layer 112. The waveguide 120 is formed through the first layer 111 and the second layer 112, and the drawing shows an embodiment in which an opening of the waveguide 120 is formed in the upper surface of the first layer 111 and a feeding part of the waveguide 120 is formed in the lower surface of the second layer 112.

Referring to FIG. 4, the body 110 of the antenna 100 according to the present embodiments may include one first layer 111 and a pair of second layers 112 thermally fused to two opposite side surfaces, respectively, of the first layer 111. The pair of second layers 112 are thermally fused to the upper and lower surfaces, respectively, of the first layer 111. In FIG. 4, an opening of the waveguide 120 is formed in the upper second layer 112, a feeding part of the waveguide 120 is formed in the lower second layer 112, and a portion of the waveguide 120 is formed in the intermediate first layer 111.

The antenna 100 according to the present embodiments may include a plurality of first layers 111 and a plurality of second layers 112, and the first layers 111 and the second layers 112 may be thermally fused, and the plurality of layers may be stacked.

According to an embodiment, the first layer 111 may be formed of a nonferrous metal, e.g., aluminum which is lightweight and has good processability. According to an embodiment, the second layer 112 may be formed of engineering plastic, e.g., polyphenylene sulfide (PPS) which has excellent strength, heat resistance, and chemical resistance.

According to an embodiment, micropores may be formed in the surface of the first layer 111 bonded with the second layer 112. In other words, by the micropores, when the heated first layer 111 is bonded to the second layer 112, the second layer 112, which is a resin, may be partially melted, penetrate into the micropores of the first layer 111, and then cool, thereby maximizing the bonding force by thermal fusion. The micropores are formed on the surface of the first layer 111 bonded with the second layer 112. In other words, in the embodiment illustrated in FIG. 3, micropores are formed on the lower surface of the first layer 111. Further, in the embodiment illustrated in FIG. 4, micropores are formed on two opposite surfaces of the first layer 111.

According to an embodiment, the micropores may be formed by chemically treating the surface of the first layer 111. In other words, in the present embodiments, micropores may be formed by chemically treating the surface of the first layer 111 formed of metal.

According to an embodiment, the micropores may be formed by immersing the surface of the first layer 111 in an oxidizing material. Further, the micropores may be formed by applying an oxidizing material to the surface of the first layer 111. Here, the oxidizing material for forming micropores may be sulfuric acid or hydrochloric acid.

Further, according to an embodiment, the chemically treated surface of the first layer 111 may be washed. In other words, the surface of the first layer 111 immersed in the oxidizing material or coated with the oxidizing material may be washed after micropores are formed, and may be thermally fused with the second layer 112.

Hereinafter, a method for manufacturing an antenna according to the present embodiments is described with reference to FIG. 5. According to the present embodiments, there may be provided a method for manufacturing an antenna 100 according to the present embodiments, comprising preparing a first layer 111 and a second layer 112 (step S510), heating the first layer 111 (step S520), and bonding the first layer 111 and the second layer 112 (step S530).

The first layer 111 is formed of metal, and the second layer 112 is formed of resin. The first layer 111 may be manufactured by processing or die casting. The second layer 112 may be manufactured by processing or injection molding.

According to an embodiment, the first layer 111 may be formed of a nonferrous metal, e.g., aluminum which is lightweight and has good processability.

According to an embodiment, the second layer 112 may be formed of engineering plastic, e.g., polyphenylene sulfide (PPS) which has excellent strength, heat resistance, and chemical resistance.

According to an embodiment of the disclosure, the step S510 of preparing the first layer 111 and the second layer 112 may include forming micropores in a surface of the first layer 111 bonded with the second layer 112.

According to an embodiment, the step of forming the micropores in the first layer 111 may include chemically treating the surface of the first layer 111.

According to an embodiment, in the step of chemically treating the surface of the first layer 111, the surface of the first layer 111 may be immersed in an oxidizing material.

Further, in the step of chemically treating the surface of the first layer 111, an oxidizing material may be applied to the surface of the first layer 111.

Here, the oxidizing material for forming micropores in the first layer 111 may be, for example, but not limited to, sulfuric acid or hydrochloric acid.

Further, according to an embodiment, the step of forming the micropores in the first layer 111 may further include washing the chemically treated surface of the first layer 111.

According to an embodiment, in the step S520 of heating the first layer 111, the first layer 111 may be heated to a temperature of 250 degrees or more.

According to an embodiment, in the step S530 of bonding the first layer 111 and the second layer 112, the first layer 111 and the second layer 112 may be pressed with a force of 20N or more for 10 seconds or more so that the second layer 112 of resin is melted by the high temperature of the first layer 111 and cooled.

By the structured antenna and the method for manufacturing the same according to some embodiments of the present disclosure, it is possible to save the weight and material costs by reducing the number of components and assembly processes, reduce the overall size, prevent damage during the assembly process, and provide enhanced quality.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. An antenna, comprising:
a body including at least one first layer formed of metal and at least one second layer formed of resin, the first layer and the second layer thermally fused to each other; and
a waveguide formed in the body.

2. The antenna of claim 1, wherein the metal of the first layer comprises aluminum.

3. The antenna of claim 1, wherein the resin of the second layer comprises polyphenylene sulfide (PPS).

4. The antenna of claim 1, wherein a surface of the first layer bonded to the second layer has micropores.

5. The antenna of claim 4, wherein the surface of the first layer having the micropores is a chemically treated surface.

6. The antenna of claim 5, wherein the surface of the first layer having the micropores is a surface to which an oxidizing material is applied.

7. The antenna of claim 1, wherein the at least one first layer comprises one first layer and the at least one second layer comprises a pair of second layers, and one surface of the one first layer formed of the metal is bonded to one of the pair of second layers and another surface of the one first layer formed of the metal is bonded to another of the pair second layers.

8. An antenna comprising:
a body including at least one first layer formed of metal and at least one second layer formed of resin, wherein the first layer and the second layer are bonded to each other and a part of the second layer formed of the resin is disposed in micropores formed in a surface of the first layer bonded to the second layer; and
a waveguide formed in the body.

9. The antenna of claim 8, wherein the metal of the first layer comprises aluminum.

10. The antenna of claim 8, wherein the resin of the second layer comprises polyphenylene sulfide (PPS).

11. The antenna of claim 8, wherein the at least one first layer comprises one first layer and the at least one second layer comprises a pair of second layers, and one surface of the one first layer formed of the metal is bonded to one of the pair of second layers and another surface of the one first layer formed of the metal is bonded to another of the pair second layers.

12. A method for manufacturing an antenna, the method comprising:
heating a first layer formed of metal; and
bonding the heated first layer formed of the metal and a second layer formed of resin so that the first layer and the second layer are thermally fused to each other to form a waveguide in a body of the antenna.

13. The method of claim 12, wherein the metal of the first layer comprises aluminum.

14. The method of claim 12, wherein the resin of the second layer comprises polyphenylene sulfide (PPS).

15. The method of claim 12, further comprising forming micropores in a surface of the first layer bonded to the second layer.

16. The method of claim 15, wherein the forming of the micropores in the surface of the first layer includes chemically treating the surface of the first layer bonded to the second layer.

17. The method of claim 16, wherein the chemically treating of the surface of the first layer comprises immersing the surface of the first layer bonded to the second layer in an oxidizing material.

18. The method of claim 16, wherein the chemically treating of the surface of the first layer comprises applying an oxidizing material to the surface of the first layer bonded to the second layer.

19. The method of claim 17, wherein the oxidizing material is sulfuric acid or hydrochloric acid.

20. The method of claim 16, wherein the forming of the micropores in the surface of the first layer further includes washing the chemically treated surface of the first layer.
